(19) United States
(12) Patent Application Publication
(10) Pub. No.: US 2026/0178332 A1
(43) Pub. Date: Jun. 25, 2026

(54) SYSTEMS AND METHODS FOR EARLY EXIT FROM A STATIC LOOP NEST

(71) Applicant: Meta Platforms Technologies, LLC, Menlo Park, CA (US)

(72) Inventors: Sruthikesh Surineni, Austin, TX (US); Xu Chen, San Jose, CA (US); Sabarish Sankaranarayanan, San Jose, CA (US); Kyong Ho Lee, Los Altos, CA (US); Rexford Hill, San Diego, CA (US); Harshit Khaitan, Fremont, CA (US)

(21) Appl. No.: 19/427,996

(22) Filed: Dec. 19, 2025

Related U.S. Application Data
(60) Provisional application No. 63/737,426, filed on Dec. 20, 2024.

(51) Int. Cl. G06F 9/30; G06F 9/32

(52) U.S. Cl. CPC G06F 9/30065; G06F 9/325

(57) ABSTRACT

A computer-implemented method may include receiving, by a tensor controller, a target loop count. The computer-implemented method may also include performing, by the tensor controller, an early exit from a static loop nest based at least in part on the target loop count. Various other devices, systems, and methods are also disclosed.

### CROSS-REFERENCE TO RELATED APPLICATIONS

This application claims priority to U.S. Provisional Application No. 63/737,426, entitled “Systems and Methods for Early Exit from a Static Loop Nest”, filed Dec. 20, 2024, which is hereby incorporated by reference in its entirety.

### BRIEF DESCRIPTION OF THE DRAWINGS

FIG. 1 is an illustration of example convolution pseudocode.

FIG. 2 is an illustration of example tensor controller pseudocode.

FIG. 3 is a block diagram illustrating an example tensor controller.

FIG. 4 is a flow diagram illustrating a multi-head attention process in a transformer.

FIG. 5 is an illustration of example counter stack pseudocode implementing early exit from a static loop nest by a tensor controller.

FIG. 6 is an illustration of example early exit logic pseudocode implementing early exit from a static loop nest by a tensor controller.

FIG. 7 is a graphical illustration demonstrating an example current loop construction without early exit from a static loop nest.

FIG. 8 is a graphical illustration demonstrating an example current loop construction with early exit from a static loop nest.

FIG. 9 is an illustration of example compiler pseudocode for converting strides into address incremented instruction set architecture fields.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

### DETAILED DESCRIPTION

The present disclosure is generally directed to systems and methods for early exit from a static loop nest. For example, a tensor controller may receive a target loop count (e.g., from a digital signal processor) perform an early exit from a static loop nest based at least in part on the target loop count. In this way, a tensor controller may avoid extra data fetch and computation by finishing the tensor controller iteration early when a certain condition is met. Many types of networks can benefit from an early exit as disclosed herein, and one such type of network can correspond to large language models (LLMs). However, LLMs are but one example type of network discussed herein for purposes of illustration, and it should be understood that the early exit can be implemented in other types of networks.

Improved hardware efficiency may be realized by the disclosed systems and methods. In this context, the disclosed systems and methods may implement the early exit with adder-based address pattern generation. In such implementations, a hardware implementation may avoid including a multiplier, a divider, or one tracked address per dimension. For example, elimination of multipliers and one tracked address per dimension may be accomplished by converting sum(stride*loopIter) into incremental changes between iterations and introducing conversion of stride to addr_incr. Early exit may, thus, replace counter-max with (target−init)/elem_incr. Additionally, elimination of dividers may be achieved by incrementing per elem_incr and breaking the loop when elem count≥target. Also, a number of tracked addresses per dimension may be reduced (e.g., minimized) by updating stride to addr_incr conversion logic as detailed herein, which may result in a requirement of one tracked address per early exit variable instead of one tracked address per loop dimension.

Unlike many conventional machine learning networks, LLMs require dynamism as they interactively take a sequence of user inputs and generate a sequence of responses whose sizes are not available at compile time. Specifically, the length of the user input (seq_len) and then length of the context of the conversation (kv_seq_len) are unknown at compile time. One approach to try to handle these run-time variables is to create multiple binaries for different values of seq_len and kv_seq_len. This requires iterating a memory region larger than the actual seq_len and kv_seq_len, which requires extra padding data outside of seq_len and kv_seq_len. As LLMs are typically memory bound, this adds extra overhead to performance.

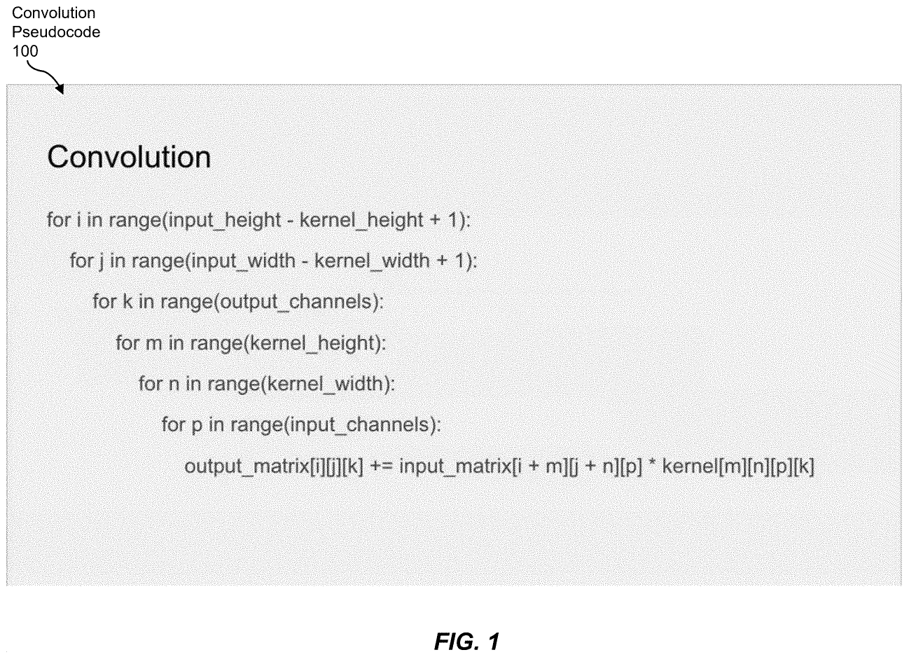

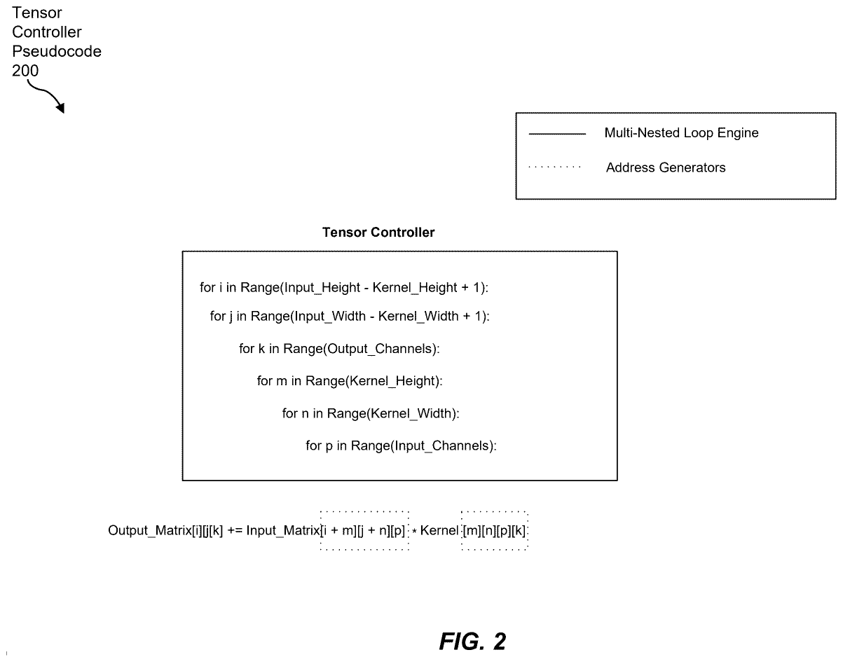

Details regarding custom processors and/or hardware accelerators and related agents are provided herein with reference to FIGS. 1-4. For example, FIG. 1 demonstrates example convolution pseudocode 100. As shown in FIG. 1, a convolution carried out in a custom processor and/or hardware accelerator process may involve a plurality of nested loops (e.g., for-loops). In this context, a loop nest may be configured as an intrinsic primitive for which an output tensor may be determined for a plurality of indices of a binary based on an input tensor and a weight tensor. As shown in FIG. 2, example tensor controller pseudocode 200 may receive an instruction specifying a loop nest of multiple loops within the same instruction and walk through input tenor and weight tensor based on address generators to generate all of the outputs of the output tensor.

In some embodiments, the tensor controller may be configured to execute loop nests that define iteration patterns over multi-dimensional data structures. The tensor controller may include address generators that compute memory addresses for accessing elements of input tensors, weight tensors, and output tensors during execution of the loop nest. The address generators may operate based on stride values and loop iteration counts to determine appropriate memory locations for data access operations.

In some embodiments, the tensor controller may support token-based synchronization between multiple tensor controllers operating in a producer-consumer relationship. A producer tensor controller may generate tokens upon completion of innermost loop iterations, and these tokens may be consumed by a downstream tensor controller to trigger corresponding data consumption operations. This synchronization mechanism may enable pipelined execution of tensor operations across multiple hardware units.

In some embodiments, the tensor controller may be configured to handle both static and dynamic loop bounds. For static loop bounds, the iteration counts may be determined at compile time and encoded directly in the instruction. For dynamic loop bounds, the tensor controller may receive runtime parameters through control status registers (CSRs) that specify the actual iteration counts to be used during execution.

The tensor controller may include a counter stack component that manages the state of nested loop iterations. The counter stack may track the current iteration index for each level of the loop nest and may determine when to advance to the next iteration or exit a particular loop level. The counter stack may also coordinate with the address generator to ensure that memory addresses are updated appropriately as loop iterations progress.

In some implementations, the tensor controller may support multiple independent address tracking mechanisms for different tensor operands. Each address tracking mechanism may maintain its own base address, stride values, and current address state. This may enable the tensor controller to simultaneously access multiple tensors with different memory layouts during a single loop nest execution.

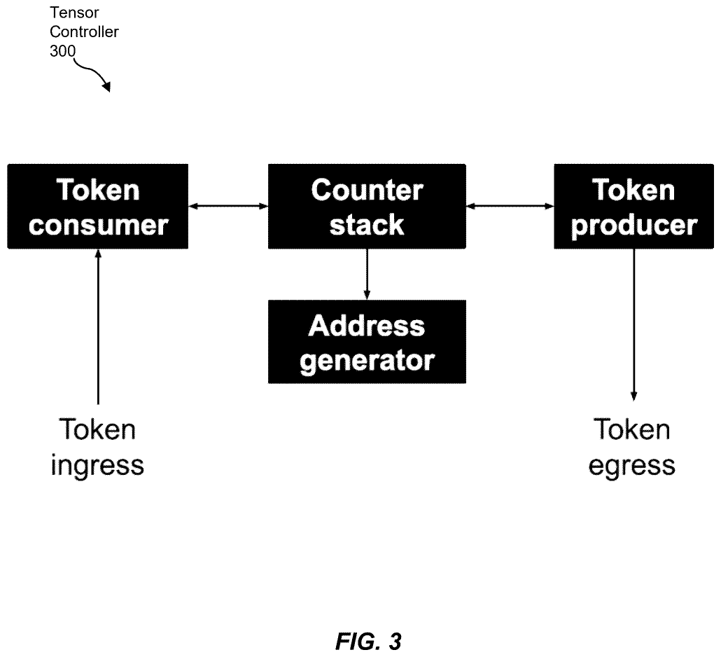

As shown in FIG. 3, an example tensor controller 300 may have built in address generators. One tensor controller may produce data and another may consume it. Tokens may be produced and/or consumed in various (e.g., any or all) levels of a loop as programmed by a compiler. For example, the loop nests executed by these tensor controllers may be tied together so that when the producer finishes an innermost set of loops, it generates a token. This token may wake up a downstream tensor controller, inform it of the memory locations of the produced results, and trigger it to start its innermost loop nest loop to consume the corresponding block of data. This type of operation relies on the instructions being effectively static due to the static nature of the compute graph. However, dynamic processes, such as those involved with large language models, are becoming more common.

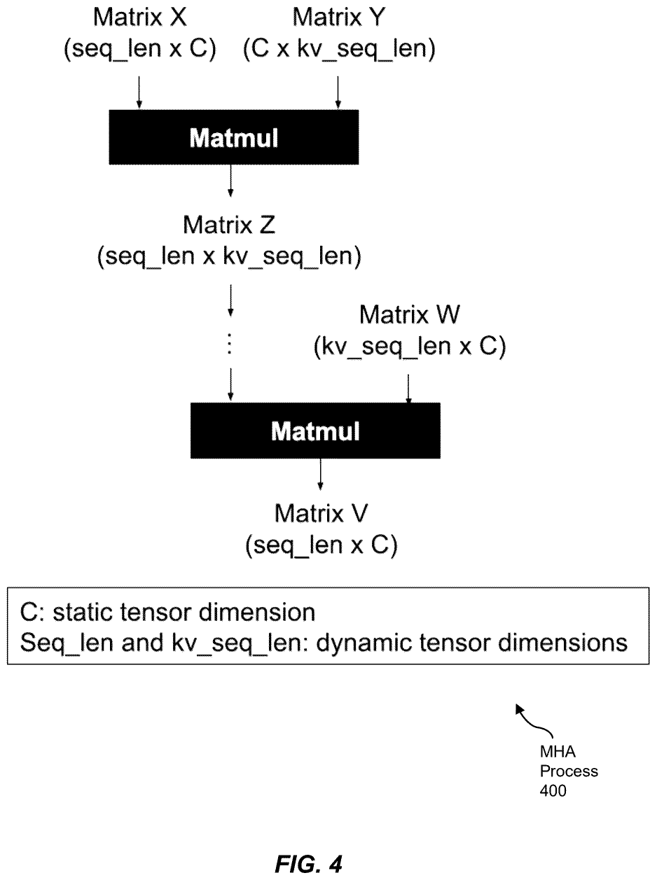

As shown in FIG. 4, a simplified example transformer graph model of a multi-head attention process 400 in a transformer may correspond to a part of a full model graph for purposes of illustration. The multi-head attention process 400 may involve two variables (e.g., Seq_len and Kv_seq_len) that are dynamic. Seq_len may correspond to a length of an input sequence and Kv_seq_len may correspond to a length of what has already been processed in the sequence (e.g., context). These variables may result in dynamic graphs. Processing these dynamic graphs may involve allocating a static graph of a fully compiled size, resulting in extra data fetch and computation. The disclosed systems and methods may avoid the extra fetch and computation by providing a capability to generate efficient instructions and clip them off in any direction through an early exit that may be configured dynamically on a loop specific basis.

Early exit is a feature to avoid extra data fetch and computation by finishing the tensor controller iteration early when a certain condition is met. New control status registers (CSRs) for firmware (FW) may be added to provide support for dynamism and new instruction set architecture (ISA) fields may be added to support the early exit feature. Before FW runs a custom processor and/or hardware accelerator binary, the FW may first configure the CSRs. For example, in LLM, the FW may set one CSR to seq_len and another CSR to kv_seq_len. There may also be a contract between the FW and the compiler regarding which CSR is used for seq_len or kv_seq_len. A tensor controller may then take the CSRs and ISA fields to implement the early exit operation. The tensor controller may further have a counter stack and address generator (adrgen). The counter stack may run nested for-loops and handle token synchronization. Adrgen may monitor the loop counters and increase and/or decrease the output address (or output control signals).

In one aspect, the disclosed systems and methods may include providing new CSRs for FW to configure support for dynamism and new ISA fields to support the early exit feature. As LLMs have two run-time variables (i.e., seq_len and kv_seq_len), two sets of ISA fields may support up to two dynamic variables. The CSRs may be shared across all custom processor and/or hardware accelerator agents. They may even be shared across multiple custom processor and/or hardware accelerator features where dynamic variables are required. In some implementations, FW may configure the CSRs with one or more dynamic parameters at run time. The binary may take those CSR values during operation and determine when the tensor controller should exit earlier than is statically configured.

In some embodiments, the ISA fields for early exit may include an early exit initialization value, an early exit increment value, an early exit loop index, and an early exit selection value. The early exit initialization value may specify an initial count from which the early exit counter begins. The early exit increment value may specify an amount by which the early exit counter is incremented each time the associated loop advances. The early exit loop index may identify which loop in the nested loop structure is associated with the early exit condition. The early exit selection value may specify which CSR contains the target value against which the early exit counter is compared.

In some embodiments, the tensor controller may support multiple independent early exit conditions operating simultaneously. For example, a first set of early exit ISA fields may be associated with a first dynamic variable such as seq_len, while a second set of early exit ISA fields may be associated with a second dynamic variable such as kv_seq_len. These multiple early exit conditions may operate independently, allowing the tensor controller to handle multiple dynamic dimensions within a single loop nest execution.

In some embodiments, the early exit mechanism may be configured on a per-instruction basis. Each instruction executed by the tensor controller may include its own early exit configuration, allowing different instructions to have different early exit behaviors even when operating on the same underlying data structures. This per-instruction configurability may provide flexibility in handling various tensor operations with different dynamic characteristics.

In some embodiments, the CSRs used for early exit may be accessible to firmware through a defined interface. The firmware may write target values to the CSRs before initiating execution of a custom processor and/or hardware accelerator binary. The tensor controller may read these CSR values during execution to determine the appropriate early exit thresholds. This separation between firmware configuration and hardware execution may allow the same compiled binary to be used with different dynamic parameter values without recompilation.

In some embodiments, various instruction types may include ISA fields to support early exit functionality. For example, computation instructions (COMP), non-linear unit instructions (NLU), and fill instructions (FILL) may include early exit enable fields, early exit selection fields, and early exit loop index fields. The early exit enable fields may comprise single-bit values that independently enable or disable early exit for dynamic variables. The early exit selection fields may comprise values that specify which CSR contains the target value for the early exit conditions. The early exit loop index fields may identify which loop in the nested loop structure is associated with each early exit condition, and may comprise values for COMP and NLU instructions or values for FILL instructions.

In some embodiments, direct memory access (DMA) instructions may include separate early exit loop index fields for read operations and write operations. A read early exit loop index field may identify which loop is associated with early exit during data read operations, while a write early exit loop index field may identify which loop is associated with early exit during data write operations. This separation may allow DMA instructions to handle different early exit behaviors for input data fetching and output data storing within the same instruction.

In some embodiments, warp instructions may include multiple sets of early exit loop index fields corresponding to different data paths. For example, a warp instruction may include a matrix vector early exit loop index field, an input early exit loop index field, and a write early exit loop index field. The matrix vector early exit loop index field may specify early exit behavior for matrix-vector operations. The input early exit loop index field may specify early exit behavior for input data access. The write early exit loop index field may specify early exit behavior for output data writing. Each of these fields may support two independent early exit conditions corresponding to the two dynamic variables.

In some embodiments, address generator macros may include address stride enable fields to support early exit address tracking. An address generator macro (ADRGEN) and an upsampling address generator macro (ADRGENUPSAMP) may each include address stride enable fields comprising two single-bit values. These fields may control whether the address generator uses stride-based address computation for each of the two early exit conditions. When an address stride enable field is set, the address generator may track addresses independently for the corresponding early exit variable, which may enable correct address computation when early exit occurs at a loop level that affects address calculation.

In another aspect, before the FW runs a custom processor and/or hardware accelerator binary, the FW may first configure the CSRs. For example, in LLM, the FW may set one CSR to seq_len and another CSR to kv_seq_len. There may be a contract between the FW and the compiler as to which CSR is used for seq_len or kv_seq_len. A tensor controller may then take the CSRs and ISA fields to implement the early exit operation.

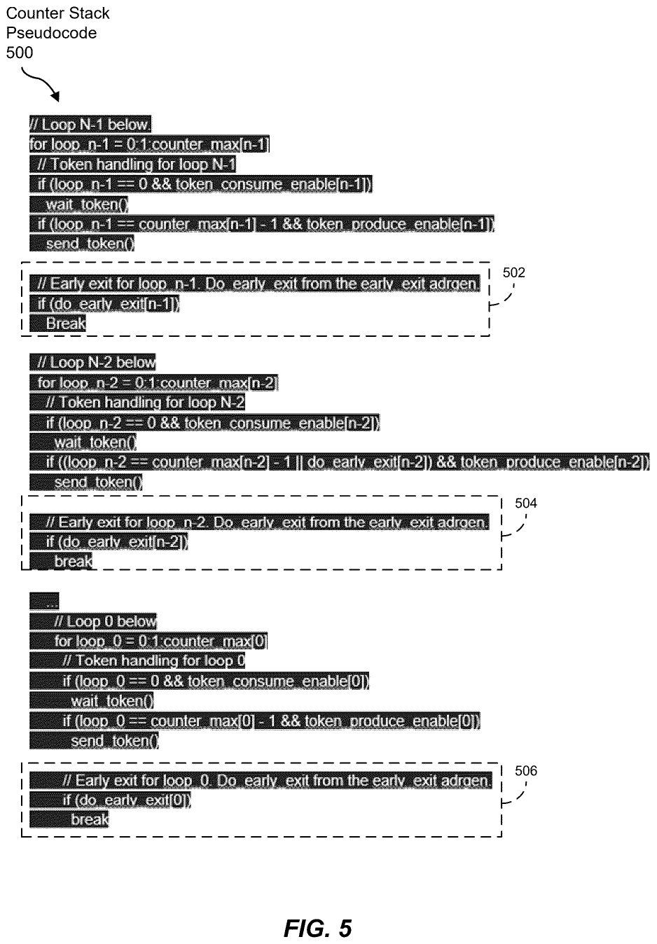

The tensor controller may have a counter stack and address generator (hereafter adrgen). The counter stack may run nested for-loops and handle token synchronization. The adrgen may monitor the loop counters and increase/decrease the output address (or output control signals). FIG. 5 demonstrates example pseudo-code 500 for the counter stack, with changes 502, 504, and 506 to support early exit. Pseudocode 500 may include a total of N nested for-loops. In each loop, pseudocode 500 may handle token consumption and token production (already supported in HW). The counter stack may also monitor do_early_exit values from adrgen in each loop and break the loop accordingly for an early exit.

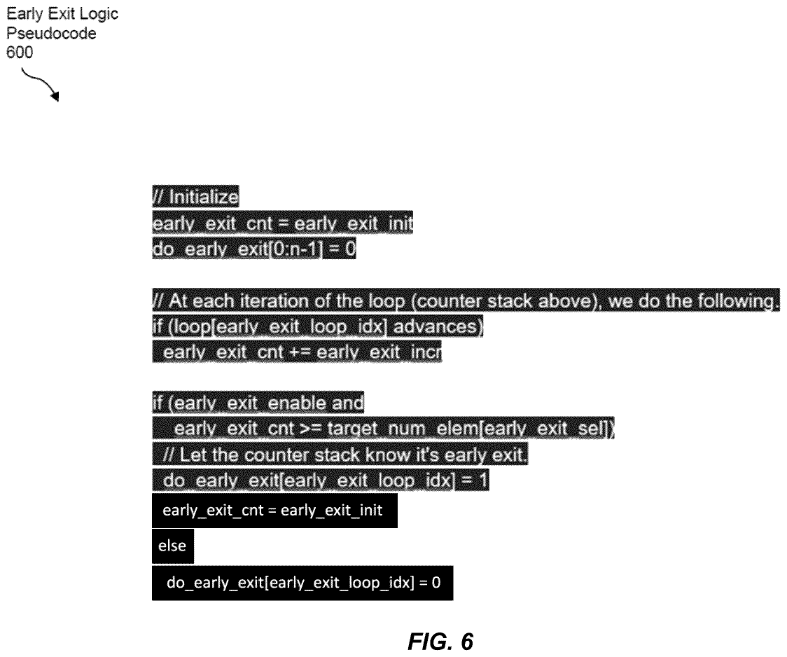

FIG. 6 demonstrates example pseudocode 600 for early exit logic. Pseudocode 600 is for one set of early exit support. Two sets of early exit ISA fields may run independently. In the early exit logic, a counter (early_exit_cnt) may be initialized to early_exit_init. Early_exit_loop_idx may be the index of the nested for-loop to which this logic is linked (i.e., the early exit loop). Whenever that particular loop is advanced, the adrgen may increase the counter by early_exit_incr. If the counter value is greater than or equal to the early exit target set by target_num_elem[early_exit_sel], then the adrgen may signal the particular loop in the stack counter with do_early_exit=1, and the counter (early_exit_cnt) is set to the early_exit_init (e.g., the counter is set to the initialization value). Otherwise, the adrgen may signal the particular loop in the stack counter with do_early_exit=0.

In another aspect involving token synchronization, a scenario may theoretically be created in which the token synchronization does not work with early exit: one instruction runs with early exit while another instruction does not. However, in actual use, the chain of instructions, DMA computation instructions, may run on the same tensor and token synchronization may be performed between the loops that iterates the same dimension of the tensor. In actual use, for example, the loop iterating H dim of the tensor in a DMA instruction may produce a token for the loop iterating C dim of the tensor in the computation instruction. Even without the early exit feature, if a DMA instruction has a token sync in a particular loop that processes H dim, the computation instruction also has a token sync at the H dim loop. By performing token-sync between H-dim in DMA and C-dim in computation, they will produce or consume different number of tokens which results in system hang. Accordingly, with and without early exit, the number of token syncs naturally matches between instructions and does not result in system hang. This, of course, assumes that both DMA and computation instructions have early-exit loops at corresponding loops (H-dim or C-dim). The number of produced tokens and consumed tokens between a pair of instructions, thus, may be the same.

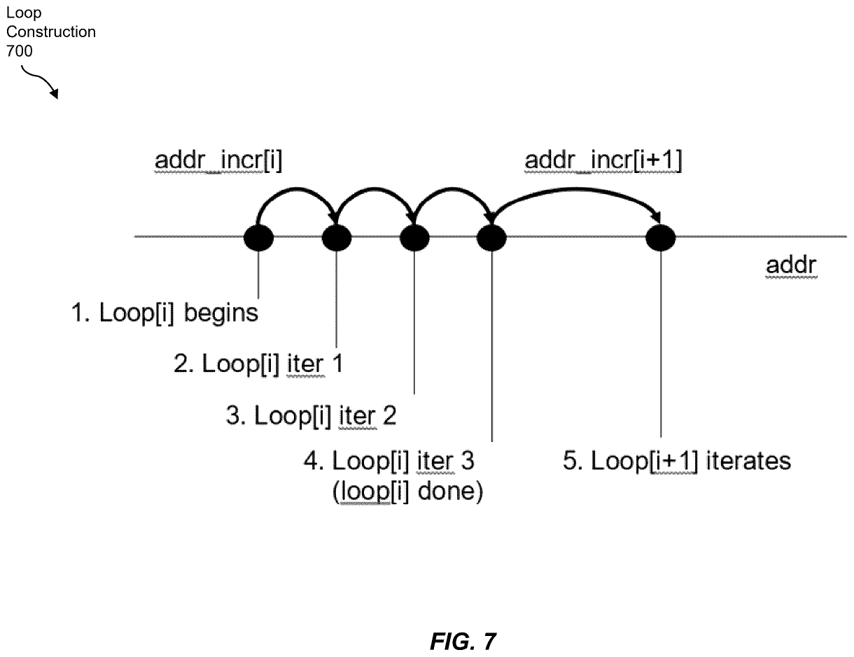

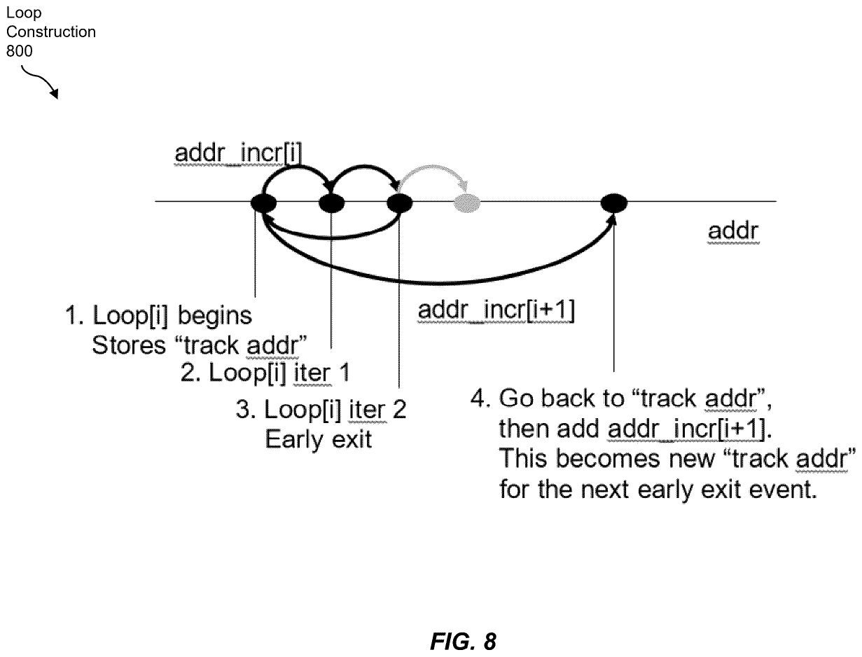

In another aspect involving finding a correct address at early exit, a tensor controller may set the addr_incr ISA field as the difference between the address of the loop[i+1] at the first iteration of loop[i+1] and the address of the loop[i] at the last iteration of loop[i]. When loop[i] is the early exit loop, then as the number of iterations of the early exit loop is unknown at compile time, the addr_incr also becomes dynamic at runtime. This implies the addr_incr of loop[i+1] may be independent from loop[i] (i.e., the early exit loop). This may be realized by keeping track of the address for the loop above the early exit loop (i.e., loop[i+1]). More specifically, hardware (HW) may record the current address whenever the loop[i+1] iterates (i.e., tracked_addr). At early exit of loop[i], the output addr may go back to the tracked_addr, then add addr_incr of loop[i+1]. This implies that addr_incr of loop[i+1] now becomes the stride rather than the addr diff between loop[i+1] and loop[i]. FIGS. 7 and 8 demonstrate application of these steps.

FIG. 7 demonstrates an example of a loop construction 700 without early exit. In this example, a tensor controller may iterate the address space (i.e., the x-axis). Loop[i] may iterate 3 times with addr_incr[i] (step 1-4). Suppose that is the end of loop[i], loop[i+1] iterates. This may be performed by adding addr_incr[i+1] to the last address of loop[i].

FIG. 8 demonstrates an example of a loop construction 800 with early exit. In this example, suppose loop[i] is the early exit loop. It iterates twice, then performs early exit (e.g., steps 1-3). Returning to the “tracked_addr,” it may then add addr_incr[i+1] which now specifies the stride within loop[i+1]. The final address may then become the new “tracked_addr”. In supporting multiple early exit loops, the basic scheme does not change and multiple tracked_addrs may be supported by computing the new address based on the addr_incr of the loop that iterates. If early exit occurs, the corresponding tracked_addr may be updated with the new address. This procedure (i.e., going back to the tracked_addr) may be controlled by configuring an ISA bit to select between the procedures described herein with reference to FIG. 7 and FIG. 8. If the ISA bit is disabled, the addr_incr may be added to the output addr without going back to the tracked_addr. This may be useful to implement a circular buffer with early exit as described below.

The disclosed systems and methods may employ various types of ISA bits to control loop behavior. For example, a first ISA bit may be set to false to disable early-exit behavior and set to true to enable early-exit behavior. Additionally, a second ISA bit may control behavior of an address increment when the first ISA bit is set to true, and may cause a particular early-exit loop to run in a circular buffer mode when the first ISA bit is set to false. Thus, the disclosed systems and methods may provide a switch that can enable and disable loop behaviors in hardware. Various ways in such a switch can be used in different cases are detailed herein.

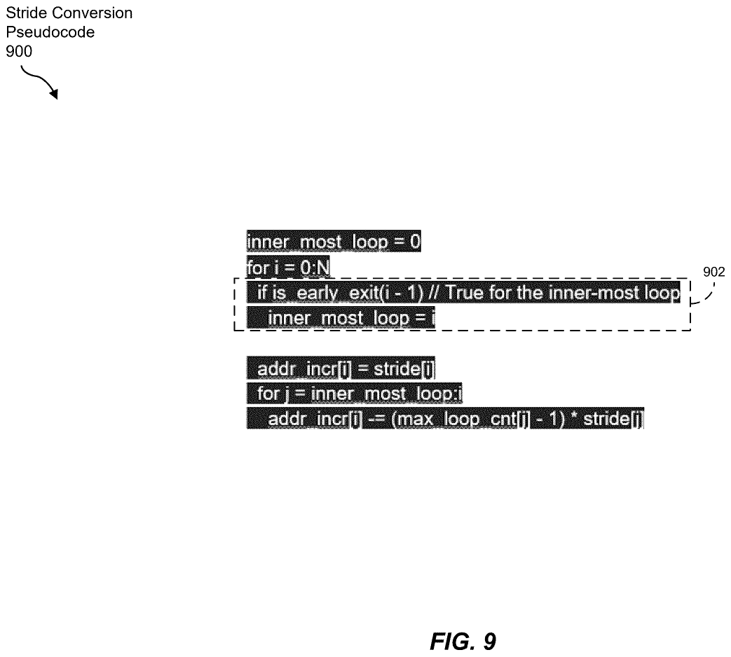

FIG. 9 demonstrates example pseudocode 900 for a compiler to convert strides into addr_incr ISA fields. Change 902 may support early exit by the tensor controller. As described above, addr_incr may be programmed with early exit. In an aspect, the following systematic approach may update the addr_incr with and without the early exit. In the preceding example, the loop above the early exit loop (i.e., loop[i+1]) does not care about the address of the loops below it. The addr_incr[i+1] may be set to be the stride within the loop[i+1]. Set addr_incr for the inner-most loop may be set in the same way. This approach may configure addr_incr of the loops above the early exit loop as if the loop right above the early exit loop is the inner-most loop. The same scheme may be applied over multiple early exit loops, for example, by taking the loops between the loop above the first early exit loop and the second early exit loop and configuring addr_incr as if the loop above the first early exit loop is the inner-most loop.

Another aspect may relate to circular buffer implementation. As mentioned, an ISA bit may be used to implement a circular buffer in the memories. A circular buffer may be implemented at least two ways. For example, one option may be to use multiple loops where the inner loop iterates over the N blocks of the circular buffer and the outer loop moves the address to the first address of the circular buffer as in the example loop-nest below:
For iter=0:1:M→change address back to the 1st buffer
   For n_buf=0:1:N→iterating N buffers
      Output_addr=circ_buffer_base+n_buf*single_buffer_size
         Another option may be to use addr_min/max with a single loop as in the example below:
Addr_min=Circ_buffer_base
Addr_max=circ_buffer_base+N*single_buffer_size
For iter=0:1:M*N
   Output_addr=circ_buffer_base+iter*single_buffer_size

In an example, a circular buffer implementation with early exit may iterate the N buffers sequentially and avoid the address not wrapping before it reaches the end of the N-th buffer. For example, in double buffering, the case may be avoided that: buf0→buf1→buf0→early exit→buf0 because the data producer overwrites buf0 before the data consumer reads it.

In the first option, there are three cases for the locations of the early exit loop.
I) Early exit loop below n_buf

In this case, we keep ISA bit=True and set addr_incr[n_buf] to be single_buffer_size
ii) n_buf is the early exit loop

There is no way that we know when the n_buf loop early exits at compile time. So it is advised to implement the loop like the second option so that the wraparound is done by addr_min and addr_max.
iii) iter and above is the early exit loop

This does not affect the circular buffering capability. No need for special care.

Similarly, in the second option, there are three cases for the locations of the early exit loop.
I) Early exit loop below iter

This early exit loop (and below) is expected to iterate a single buffer. We set ISA bit=True and set addr_incr[iter] to be single_buffer_size
ii) Iter or above is the early exit loop

The role of the iter and its outer loops are to give single_buffer_size stride in each iteration. HW will wrap around the memory based on addr_min and addr_max. So we set ISA bit=False and set addr_incr to be single_buffer_size.

As set forth above, the disclosed systems and methods may involve changes at a register transfer level (RTL), changes to a tensor controller firmware (FW), and/or changes to a compiler. For example, at the RTL, new CSRs and ISA fields may be added to all instructions, a tensor controller counter stack may be implemented for early exit handling, and tensor controller logic may be added for early exit detection and address tracking. Regarding the FW, CSRs may be configured before running a custom processor and/or hardware accelerator binary, and a contract may be implemented between the FW and compiler as to which CSR is associated with a particular runtime variable. For the compiler, the aforementioned contract between the FW and compiler as to which CSR is associated with a particular runtime variable may also be implemented. Moreover the compiler may configure the new ISA fields and configure addr_incr with the new algorithm.

In some embodiments, input activations, weight activations, and output activations may be stored in external memory. To map computation in such configurations, a plurality of instructions may be utilized. For example, an activation DMA ingress instruction may transfer data from external memory to a DMA data buffer. An activation DMA egress instruction may transfer data from the DMA data buffer to activation memory. A weight DMA ingress instruction may transfer data from external memory to the DMA data buffer. A weight DMA egress instruction may transfer data from the DMA data buffer to a weight register file. A computation instruction (COMP) may perform tensor computations on the transferred data. A non-linear unit instruction (NLU) may apply non-linear operations to computation results. A cluster activation DMA instruction may transfer data from activation memory back to external memory. These instructions may operate in coordination with the early exit mechanism, where applicable instructions may include early exit ISA fields to support dynamic loop termination based on runtime parameters.

In some embodiments, a computation instruction may be configured to load input activations and weights each cycle to generate partial outputs. For example, the computation instruction may load a block of activations (e.g., 1×8 activations) and a block of weights (e.g., 8×32 weights) each cycle to generate partial outputs (e.g., 1×32 partial outputs). The computation instruction may include a loop nest for input activation iteration. An outer loop may iterate over a sequence length dimension (e.g., from 0 to 2048 in increments of 64), and after completion of this loop, all outputs may be generated. Token consumption may occur from an activation DMA egress source at this loop level. A next inner loop may iterate over a repeat dimension (e.g., from 0 to 384 in increments of 32), and after completion of this loop, a block of outputs (e.g., 64×384 outputs) may be generated. Token consumption may occur from a non-linear unit at this loop level. A further inner loop may iterate over a spatial dimension (e.g., from 0 to 1536 in increments of 64), and after completion of this loop, another block of outputs (e.g., 64×32 outputs) may be generated. Token consumption may occur from a weight DMA egress source at this loop level. Additional inner loops may handle double buffering in a weight register file and iteration over the weight register file to load input activations. Token production may occur at corresponding loop levels to synchronize with downstream operations. The ISA configuration for early exit may specify the early exit loop index as the sequence length loop, an early exit increment value (e.g., 64), and an early exit initialization value (e.g., 0). With such a configuration, the instruction may early-exit at a particular iteration of the sequence length loop (e.g., the second iteration) when the early exit counter meets or exceeds the target value specified in the corresponding CSR.

In some embodiments, a non-linear unit instruction may be configured to process outputs from an output buffer. For example, the non-linear unit instruction may process a block of fullsums (e.g., 1×8 fullsums) from the output buffer each cycle. The non-linear unit instruction may include a loop nest for output activation processing. An outer loop may iterate over a sequence length dimension (e.g., from 0 to 2048 in increments of 64), and after completion of this loop, all outputs may be processed. Token consumption may occur from a cluster activation DMA source at this loop level. A next inner loop may iterate over a spatial dimension (e.g., from 0 to 384 in increments of 32), and after completion of this loop, a block of outputs (e.g., 64×384 outputs) may be processed. Token consumption may occur from a computation instruction at this loop level. A further inner loop may iterate over a vertical dimension (e.g., from 0 to 64 in increments of 1), and after completion of this loop, another block of outputs (e.g., 64×32 outputs) may be processed. An innermost loop may iterate over a horizontal dimension (e.g., from 0 to 32 in increments of 8) to process outputs (e.g., 1×32 outputs) in the non-linear unit lanes. Token production may occur at corresponding loop levels to synchronize with downstream operations, including token production to a computation instruction and token production to a cluster activation DMA. The ISA configuration for early exit may specify the early exit loop index as the sequence length loop, an early exit increment value (e.g., 64), and an early exit initialization value (e.g., 0). With such a configuration, the non-linear unit instruction may early-exit at a particular iteration of the sequence length loop (e.g., the second iteration) when the early exit counter meets or exceeds the target value specified in the corresponding CSR.

In some embodiments, a cluster activation DMA instruction may be configured to transfer data from activation memory to external memory following the output order of a non-linear unit. The non-linear unit may synchronize with the cluster activation DMA whenever a block of outputs (e.g., 64×384 outputs) becomes available, and the cluster activation DMA may then iterate over a vertical dimension. The cluster activation DMA instruction may include a loop nest for output transfer. A loop may iterate over a sequence length dimension (e.g., from 0 to 2048 in increments of 64). Token consumption may occur from a non-linear unit source at this loop level, and a burst size (e.g., 64×384 outputs) may be transferred. Token production may occur to the non-linear unit at this loop level. The ISA configuration for early exit may specify the early exit loop index as the sequence length loop, an early exit increment value (e.g., 64), and an early exit initialization value (e.g., 0). With such a configuration, the cluster activation DMA instruction may early-exit at a particular iteration of the sequence length loop (e.g., the second iteration) when the early exit counter meets or exceeds the target value specified in the corresponding CSR.

In some embodiments, an activation DMA ingress instruction may be configured to transfer data from external memory to a DMA data buffer. The input activation memory layout may be arranged in row-first order. To achieve efficient DRAM bandwidth utilization, the activation DMA ingress instruction may read an entire embedding dimension. Considering a data buffer size (e.g., 16 kB), a burst size of 4×1536 elements (e.g., 6 kB) may provide suitable performance characteristics. To follow the data access order in the computation instruction, the activation DMA ingress instruction may load a number of rows (e.g., 64 rows) first, then load the entire y dimension. The activation DMA ingress instruction may include a loop nest for input activation loading. An outer loop may iterate over a sequence length dimension (e.g., from 0 to 2048 in increments of 64), and after completion of this loop, all input activations may be loaded. A next inner loop may iterate over a y dimension (e.g., from 0 to 64 in increments of 4) to load a block of input activations (e.g., 64×1536 input activations). Token consumption may occur from an activation SDMA egress source at this loop level. A read/write burst size (e.g., 4×1536 input activations) may be transferred. Token production may occur to the activation SDMA egress at this loop level. The ISA configuration for early exit may specify the early exit loop index as the sequence length loop, an early exit increment value (e.g., 64), and an early exit initialization value (e.g., 0). With such a configuration, the activation DMA ingress instruction may early-exit at a particular iteration of the sequence length loop (e.g., the second iteration) when the early exit counter meets or exceeds the target value specified in the corresponding CSR.

In some embodiments, an activation DMA egress instruction may be configured to transfer data from a DMA data buffer to activation memory. The activation DMA egress instruction may match the data access order of the computation instruction. In the ingress loop, a block of input activations (e.g., 4×1536 input activations) may be loaded at a time. Correspondingly, the egress loop may read the same block size (e.g., 4×1536 input activations) in every iteration and write them to the activation memory. After writing a larger block of input activations (e.g., 64×1536 input activations) to the activation memory, the activation DMA egress instruction may synchronize with the computation instruction. The activation DMA egress instruction may then iterate over the entire y dimension. The activation DMA egress instruction may include a loop nest for input activation transfer. An outer loop may iterate over a sequence length dimension (e.g., from 0 to 2048 in increments of 64), and after completion of this loop, all input activations may be loaded. Token consumption may occur from a computation instruction source at this loop level. A next inner loop may iterate over a y dimension (e.g., from 0 to 64 in increments of 4), and after completion of this loop, a block of input activations (e.g., 64×1536 input activations) may be transferred to activation memory. Token consumption may occur from an activation SDMA ingress source at this loop level. An innermost loop may iterate over a cluster array dimension (e.g., from 0 to 4 in increments of 1) to replicate the activation over cluster arrays. A read/write burst size (e.g., 4×1536 input activations) may be transferred. Token production may occur to the activation SDMA ingress at this loop level. Token production may also occur to the computation instruction at the outer loop level. The ISA configuration for early exit may specify the early exit loop index as the sequence length loop, an early exit increment value (e.g., 64), and an early exit initialization value (e.g., 0). With such a configuration, the activation DMA egress instruction may early-exit at a particular iteration of the sequence length loop (e.g., the second iteration) when the early exit counter meets or exceeds the target value specified in the corresponding CSR.

In some embodiments, a weight DMA ingress instruction may be configured to transfer data from external memory to a DMA data buffer. The weight DMA ingress instruction may follow the data access order of the computation instruction. A block of weights (e.g., 64×32 weights) may be loaded for a number of weight register file entries (e.g., 8 entries), and the computation instruction may reuse these weights over multiple iterations (e.g., 64 times). Subsequently, a larger block of weights (e.g., 1536×32 weights) may be loaded, followed by loading of the entire weights. This process may repeat until all of the sequence length is iterated in the input activation. The weight DMA ingress instruction may include a loop nest for weight loading. An outer loop may iterate over a repeat dimension (e.g., from 0 to 2048 in increments of 64) to reload the entire weights. A next inner loop may iterate over an x dimension (e.g., from 0 to 384 in increments of 32) to load weights over the x dimension for reuse of the input activations. A further inner loop may iterate over a y dimension (e.g., from 0 to 1536 in increments of 64) to load weights for all y dimensions for full sum generation. Token consumption may occur from a weight SDMA egress source at this loop level. A read/write burst size (e.g., 64×32 weights) may be transferred. Token production may occur to the weight SDMA egress at this loop level. The ISA configuration for early exit may specify the early exit loop index as the repeat loop, an early exit increment value (e.g., 64), and an early exit initialization value (e.g., 0). With such a configuration, the weight DMA ingress instruction may early-exit at a particular iteration of the sequence length loop (e.g., the second iteration) when the early exit counter meets or exceeds the target value specified in the corresponding CSR.

In some embodiments, a weight DMA egress instruction may be configured to transfer data from a DMA data buffer to a weight register file. The weight DMA egress instruction may follow the data access order of the computation instruction. A block of weights (e.g., 64×32 weights) may be written over a number of weight register file entries (e.g., 8 entries), and these weights may be reused over multiple iterations (e.g., 64 times). Subsequently, a larger block of weights (e.g., 1536×32 weights) may be loaded, followed by loading of the entire weights. This process may repeat until all of the sequence length is iterated in the input activation. The weight DMA egress instruction may include a loop nest for weight loading. An outer loop may iterate over a repeat dimension (e.g., from 0 to 2048 in increments of 64) to reload the entire weights. A next inner loop may iterate over an x dimension (e.g., from 0 to 384 in increments of 32) to load weights over the x dimension for reuse of the input activations. A further inner loop may iterate over a y dimension (e.g., from 0 to 1536 in increments of 64) to load weights for all y dimensions for full sum generation. Token consumption may occur from a computation instruction source at this loop level. Token consumption may also occur from a weight SDMA ingress source at this loop level. A read/write burst size (e.g., 64×32 weights) may be transferred. Token production may occur to the computation instruction at this loop level. Token production may also occur to the weight SDMA ingress at this loop level. The ISA configuration for early exit may specify the early exit loop index as the repeat loop, an early exit increment value (e.g., 64), and an early exit initialization value (e.g., 0). With such a configuration, the weight DMA egress instruction may early-exit at a particular iteration of the sequence length loop (e.g., the second iteration) when the early exit counter meets or exceeds the target value specified in the corresponding CSR.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

In some embodiments, the number of tokens produced and consumed between agents should match after an early exit.

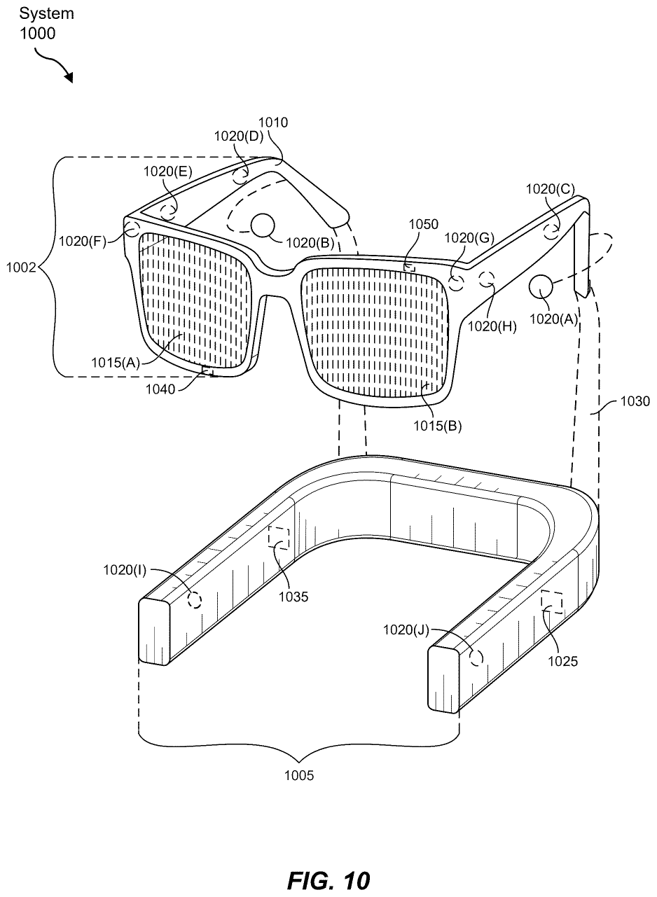

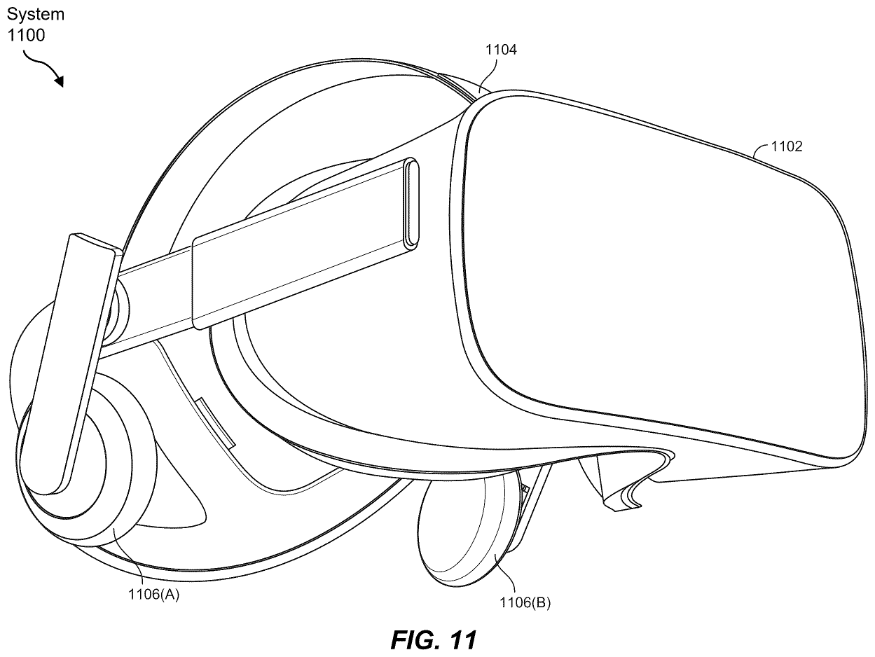

Artificial-reality systems may be implemented in a variety of different form factors and configurations. Some artificial-reality-systems may be designed to work without near-eye displays (NEDs). Other artificial—reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial—reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium-ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial—reality devices, within other artificial—reality devices, and/or in conjunction with other artificial—reality devices.

By providing haptic sensations, audible content, and/or visual content, artificial—reality systems may create an entire virtual experience or enhance a user's real-world experience in a variety of contexts and environments. For instance, artificial—reality systems may assist or extend a user's perception, memory, or cognition within a particular environment. Some systems may enhance a user's interactions with other people in the real world or may enable more immersive interactions with other people in a virtual world. Artificial—reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial—reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A computer-implemented method comprising:
receiving, by a tensor controller, a target loop count; and
performing, by the tensor controller, an early exit from a static loop nest based at least in part on the target loop count.

2. The computer-implemented method of claim 1, wherein the tensor controller receives the target loop count from a digital signal processor.

3. The computer-implemented method of claim 1, further comprising:
determining, by the tensor controller, that the early exit is enabled for a loop of the static loop nest,
wherein the tensor controller performs the early exit based at least in part on the determination.

4. The computer-implemented method of claim 1, further comprising:
incrementing, by the tensor controller, a counter when a particular loop of the static loop nest advances; and
determining, by the tensor controller, that the counter meets a threshold condition that is based at least in part on the target loop count,
wherein the tensor controller performs the early exit for the particular loop based at least in part on the determination.

5. A system comprising:
at least one physical processor;
physical memory comprising computer-executable instructions that, when executed by the physical processor, cause the physical processor to:
receive a target loop count; and
perform an early exit from a static loop nest based at least in part on the target loop count.

6. A non-transitory computer-readable medium comprising one or more computer-executable instructions that, when executed by at least one processor of a computing device, cause the computing device to:
receive a target loop count; and
perform an early exit from a static loop nest based at least in part on the target loop count.
